(19) United States
(12) Patent Application Publication
(10) Pub. No.: US 2026/0245311 A1
(43) Pub. Date: Aug. 20, 2026

(54) INFORMATION PROCESSING DEVICE, INFORMATION PROCESSING METHOD, AND COMPUTER PROGRAM

(71) Applicant: Sony Interactive Entertainment Inc., Tokyo (JP)

(72) Inventors: Kazuharu Tanaka, Kanagawa (JP); Ryotga Murasugi, Chiba (JP)

(73) Assignee: Sony Interactive Entertainment Inc., Tokyo (JP)

(21) Appl. No.: 19/161,794

(22) PCT Filed: Apr. 4, 2023
(86) PCT No.: PCT/JP2023/013882

§ 371 Date: Sep. 3, 2025

(51) Int. Cl. G06T 19/00

(52) U.S. Cl. CPC G06T 19/00; G06T 2219/024

(57) ABSTRACT

A metaverse server 12 places, in a first metaverse, an avatar corresponding to a first user using the first metaverse. A user device 14 displays an image of the first metaverse on an HMD 16. The metaverse server 12 further places, in the first metaverse, an avatar corresponding to a second user using a second metaverse that is different from the first metaverse, in a form distinct from the avatar corresponding to the first user.

### TECHNICAL FIELD

The present invention relates to a data processing technique, and more particularly to an information processing device, an information processing method, and a computer program.

### BACKGROUND ART

A metaverse which is a service of a 3D virtual space constructed in a computer, is being popularized. For example, a user operates an own avatar in the metaverse to interact with other users and participates in an event held in the metaverse.

### SUMMARY

### Technical Problem

With the increase in the number of metaverses, metaverses in undercrowded states having a few number of users are likely to be generated. When a metaverse is in an undercrowded state, the number of users who leave the metaverse increases, so that the undercrowding is accelerated. One object of the present invention is to provide a technique for making a situation where the number of users in the metaverse is small unnoticeable.

### Solution to Problem

In order to solve the above problems, an information processing device according to a certain aspect of the present invention includes an avatar setting section that places, in a first metaverse, an avatar corresponding to a first user using the first metaverse, and a display control section that displays an image of the first metaverse. The avatar setting section further places, in the first metaverse, an avatar corresponding to a second user using a second metaverse that is different from the first metaverse, in a form distinct from the avatar corresponding to the first user.

Another aspect of the present invention is an information processing method. According to this method, a computer executes a step of placing, in a first metaverse, an avatar corresponding to a first user using the first metaverse, and a step of displaying an image of the first metaverse. In the placing step, an avatar corresponding to a second user using a second metaverse that is different from the first metaverse, is further placed, in a form distinct from the avatar corresponding to the first user, in the first metaverse.

It is to be noted that a computer program or a recording medium having a computer program recorded therein, which is obtained by translating any combination of the above constituent elements or an expression in the present invention, is also effective as an aspect of the present invention.

### Advantageous Effects of Invention

The present invention can make it possible to realize presentation for making a situation where the number of users in the metaverse is small unnoticeable.

### BRIEF DESCRIPTION OF DRAWINGS

FIG. 1 is a diagram depicting a configuration of a metaverse system according to an embodiment.

FIG. 2 is a block diagram depicting main functional blocks of a user device.

FIG. 3 is a block diagram depicting main functional blocks of a metaverse server.

FIG. 4 is a flowchart of operation of the metaverse system according to the embodiment.

FIG. 5(A) is a diagram depicting an example of a conventional metaverse image, and FIG. 5(B) is a diagram depicting an example of a user world image according to the embodiment.

FIG. 6(A) is a diagram depicting an example of a conventional metaverse image, and FIG. 6(B) is a diagram depicting an example of a user world image according to the embodiment.

FIG. 7(A) is a diagram depicting an example of a conventional metaverse image, and FIG. 7(B) is a diagram depicting an example of a user world image according to the embodiment.

### DESCRIPTION OF EMBODIMENT

A brief explanation of an embodiment will be given. A metaverse of the embodiment is a 3D virtual space (which also can be called cyberspace) and a service therefor. A user participating in the metaverse operates an avatar which is a character representing the user in the metaverse, to interact with other users and also participate in an event held in the metaverse.

The embodiment suggests a technique for making a situation where the number of users in the metaverse (i.e., undercrowding in the metaverse) is small unnoticeable. Specifically, in an information processing system according to the embodiment (metaverse system 10 which will be described later), a user using a second metaverse that is different from a first metaverse is placed in the first metaverse. Accordingly, the first metaverse can look lively, so that a situation where the number of users is small becomes unnoticeable to users using the first metaverse.

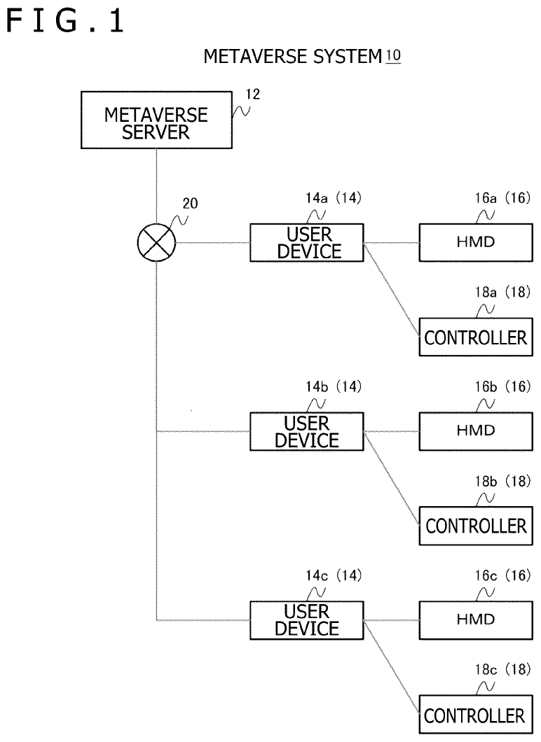

FIG. 1 depicts a configuration of the metaverse system 10 according to the embodiment. The metaverse system 10 is an information processing system that provides a metaverse service to a plurality of users. The metaverse system 10 includes a metaverse server 12 and a plurality of user systems.

The metaverse server 12 is an information processing device that executes processing related to metaverse management. In the embodiment, a metaverse provided by the metaverse server 12 is referred to as “world.” The metaverse server 12 manages a plurality of worlds created according to various themes. A world is a model of a metaverse, and a world is substantialized into a virtual space that a user participates in. Such a virtual space is called instance. In the embodiment, an instance that is substantiation of a world is called “room.” A world and a room can be replaced with a metaverse, if needed.

Among the systems of a plurality of users, a system of a user A includes a user device 14a, an HMD (head mount display) 16a, and a controller 18a. A system of a user B includes a user device 14b, an HMD 16b, and a controller 18b. A system of a user C includes a user device 14c, an HMD 16c, and a controller 18c.

The user device 14a, the user device 14b, and the user device 14c (collectively referred to as “user device 14”) are information processing devices that are operated by users using the metaverse. The user device 14 may be a PC (personal computer), a smartphone, a tablet terminal, or a game machine. The user device 14 communicates with the metaverse server 12 over a communication network 20 such as a LAN (local area network), WAN (wide area network), or the internet.

The HMD 16a, the HMD 16b, and the HMD 16c (collectively, referred to as “HMD 16,” if needed) are head mount displays to be mounted on user heads. In the embodiment, it is assumed that a display device of a user is the HMD 16, and an image of the metaverse is displayed on the HMD 16. In a modification, an image of a metaverse may be displayed on a television or a computer display. The HMD 16 is wiredly or wirelessly connected with the user device 14.

The controller 18a, the controller 18b, and the controller 18c (collectively, referred to as “controller 18”) is an operation device to which a user operation is inputted. The controller 18 is wiredly or wirelessly connected to the user device 14. The function of the user device 14, the function of the HMD 16 (display function), and the function of the controller 18 may be integrated in a single information processing device.

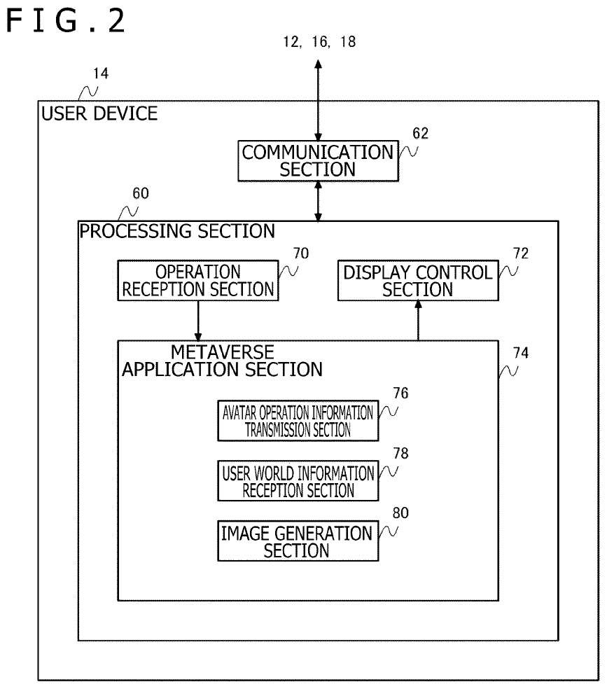

FIG. 2 is a block diagram depicting main functional blocks of the user device 14 in FIG. 1. The blocks depicted in the block diagram of the present specification can be implemented by elements, electronic circuitry, and mechanical devices such as a processor, a CPU (central processing unit), and a memory of a computer, in terms of hardware, and can be implemented by a computer program loaded into a memory, in terms of software, for example. Here, the functional blocks that are implemented in cooperation thereof are depicted. Therefore, a person skilled in the art will understand that these functional blocks can be implemented in many different ways by a combination of hardware and software.

The user device 14 includes a processing section 60 and a communication section 62. The processing section 60 executes data processing, and further, controls operation of the user device 14. The communication section 62 communicates with an external device in accordance with a prescribed communication protocol. The processing section 60 exchanges data with the metaverse server 12, the HMD 16, and the controller 18 via the communication section 62.

The processing section 60 includes an operation reception section 70, a display control section 72, and a metaverse application section 74. The functions of the multiple functional blocks included in the processing section 60 may be implemented on a computer program (e.g., system software, application software). This computer program may be stored in a recording medium, and installed in a storage of the user device 14 via the recording medium. In addition, the computer program may be downloaded over a network and installed into a storage of the user device 14. By reading out the computer program to the main memory to execute the computer program, a processor of the user device 14 may exert the functions of the multiple functional blocks.

The operation reception section 70 receives information regarding an operation inputted to the controller 18 and transmitted from the controller 18. The display control section 72 controls display contents on the HMD 16. In the embodiment, the display control section 72 transmits metaverse image data (user world image which will be explained later) generated by the metaverse application section 74, to the HMD 16, and displays the metaverse image on the HMD 16.

The metaverse application section 74 executes a user-side process regarding metaverse display. The metaverse application section 74 includes an avatar operation information transmission section 76, a user world information reception section 78, and an image generation section 80.

The avatar operation information transmission section 76 transmits avatar operation information which is indicative of a user operation for an avatar placed in the metaverse and is received by the operation reception section 70, to the metaverse server 12. For example, the avatar operation information includes information indicating the type of a button depressed in the controller 18, and information indicating the tilt direction and tilt amount of an analog stick in the controller 18.

The user world information reception section 78 receives user world information transmitted from the metaverse server 12. The user world information relates to a world (metaverse) that is being used by the user. In addition, the user world information includes information that is necessary to generate a user world image to be displayed on the HMD 16. The user world image is an image of a world (metaverse) being used by the user from the viewpoint of the user, or an image of a room that the user has entered. The user world image includes (1) data indicating the position and appearance of the user avatar and (2) data indicating the appearance of the room viewed from the viewpoint of the user (e.g., data indicating the positions and appearances of other avatars and various objects), for example.

The image generation section 80 generates a user world image according to the user world information received by the user world information reception section 78.

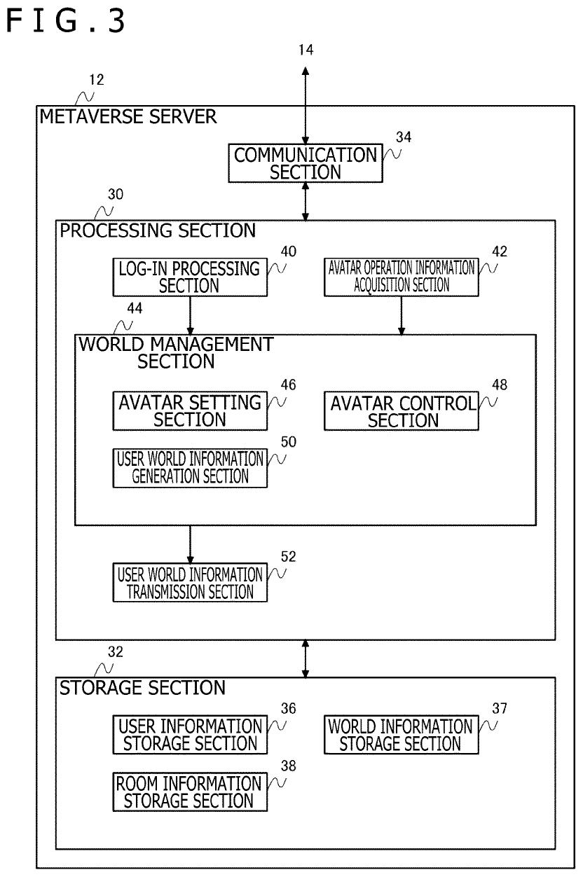

FIG. 3 is a block diagram depicting main functional blocks of the metaverse server 12 in FIG. 1. The metaverse server 12 includes a processing section 30, a storage section 32, and a communication section 34. The processing section 30 executes information processing for metaverse management. The storage section 32 stores data to be referred to or to be updated by the processing section 30. The communication section 34 communicates with an external device in accordance with a prescribed communication protocol. The processing section 30 exchanges data with the user device 14 via the communication section 34.

The storage section 32 includes a user information storage section 36, a world information storage section 37, and a room information storage section 38. The user information storage section 36 stores user information which is information regarding a user using a world under management of the metaverse server 12. The user information includes (1) user identification information and (2) information regarding the user avatar (e.g., data about the appearance).

The world information storage section 37 stores world information which is design information regarding a plurality of worlds. The world information includes (1) world identification information, (2) information regarding an object placed in a world (e.g., data about the position and the appearance), and (3) identification information of an instance (room) of a world.

The room information storage section 38 stores room information which is information regarding a room provided in each world (i.e., an instance of each world). The room information includes (1) identification information regarding a room, (2) identification information regarding a user who has entered a room, and (3) the placement positions of avatars of respective users in a room.

The processing section 30 includes a log-in processing section 40, an avatar operation information acquisition section 42, a world management section 44, and a user world information transmission section 52. The functions of the multiple functional blocks included in the processing section 30 may be implemented on a computer program (e.g., system software, application software). This computer program may be stored in a recording medium, and installed in a storage of the metaverse server 12 via the recording medium. Alternatively, the computer program may be downloaded over a network and installed in a storage of the metaverse server 12. By reading out the computer program into the main memory to execute the computer program, a processor of the metaverse server 12 may exert the functions of the multiple functional blocks.

The log-in processing section 40 receives a world log-in request transmitted from the user device 14, and executes a log-in process (e.g., authentication). If a user is successfully authenticated, the log-in processing section 40 determines to permit the user to enter one room regarding a world designated by the user and updates the room information in the room information storage section 38. The avatar operation information acquisition section 42 receives the avatar operation information transmitted from the user device 14.

The world management section 44 executes processes related to respective worlds on the basis of a plurality of sets of the world information stored in the world information storage section 37. The world management section 44 includes an avatar setting section 46, an avatar control section 48, and a user world information generation section 50.

The avatar setting section 46 places, in a room of a world, an avatar corresponding to each user using the room (i.e., a virtual space based on specific world information). The avatar setting section 46 records the placement positions of avatars of respective users in each room in the room information in the room information storage section 38.

Here, it is assumed that a user A enters a first room while a user B enters a second room which is different from the first room. The second room is an instance that is different from the first room but is based on the same world information. The avatar setting section 46 places, in the first room, an avatar corresponding to the user B having entered the second room. In addition, in the first room, the avatar setting section 46 places the avatar corresponding to the user B in a form distinct from the avatar of the user A placed in the first room.

The avatar setting section 46 sets, as the distinct form, transparency of the avatar corresponding to the user B placed in the first room to be higher than that of the avatar corresponding to the user A placed in the first room. In the embodiment, an avatar of the user A placed in the first room and displayed in a normal form is referred to as “original avatar.” Also, an avatar of the user B placed in the first room and displayed with transparency higher than that of the original avatar is referred to as “ghost avatar.” Elements (e.g., shape, etc.) of the ghost avatar excluding the transparency may be the same as those of the original avatar. Further, the ghost avatar may be a stick figure having a shape formed by deforming a human body or an avatar, for example.

Setting a distinct form is not limited to increasing the transparency. For example, for the avatar corresponding to the user B placed in the first room, the avatar setting section 46 sets a shape, a pattern, and a color that are not used for a normal avatar (original avatar). In addition, the avatar setting section 46 may add, to the avatar corresponding to the user B (which may be a ghost avatar) placed in the first room, an object that is indicative of an avatar of a user having entered a room that is different from the first room. The object may be a text, an image, or a combination thereof. For example, the object may be a sign such as a name tag describing that the avatar is an avatar in a different room.

That is, the avatar setting section 46 adds, to the avatar corresponding to the user B, an apparent feature indicating that the avatar is not a normal avatar. In actuality, the user A of the first room cannot communicate with the avatar of the user B existing in the second room. Since an apparent feature is added to the avatar of the user B, the user A is prevented from misidentifying the avatar of the user B as a normal avatar, whereby occurrence of confusion can be easily suppressed.

It is to be noted that the users B may include a plurality of users using the second room. The avatar setting section 46 places, in the first room, a plurality of ghost avatars corresponding to a plurality of users using the second room with an upper limit for the number of the ghost avatars defined to be a prescribed number. The upper limit for the number of ghost avatars that can be placed in the first room may be defined to be a suitable value based on the knowledge of a developer or an experiment using the metaverse system 10, for example. In addition, the upper limit for the number of the ghost avatars may be defined on the basis of the size of the first room as a virtual space. As the size of the first room as a virtual space is larger, a greater value may be defined as the upper limit for the number of ghost avatars. Since the upper limit for the number of ghost avatars that can be placed in one room is defined in this manner, an amount of information regarding the first room in the user world image can be prevented from becoming excessively large.

The avatar control section 48 controls behaviors of the avatars of the users in the room on the basis of the avatar operation information received by the avatar operation information acquisition section 42.

The user world information generation section 50 generates, for each user, the user world information on the basis of (1) world information regarding a world that the user has entered, (2) room information regarding a room in which an avatar of the user is placed, (3) user information regarding another user whose avatar is placed in the room, and (4) behaviors of respective avatars. By way of example, the user world information generation section 50 generates, as user world information to be provided to the user device 14a of the user A, user world information including information regarding the positions, appearances, and behaviors of objects (including the avatars) placed in the first room.

The user world information transmission section 52 transmits the user world information for respective users generated by the user world information generation section 50 to the user devices 14 of the respective users.

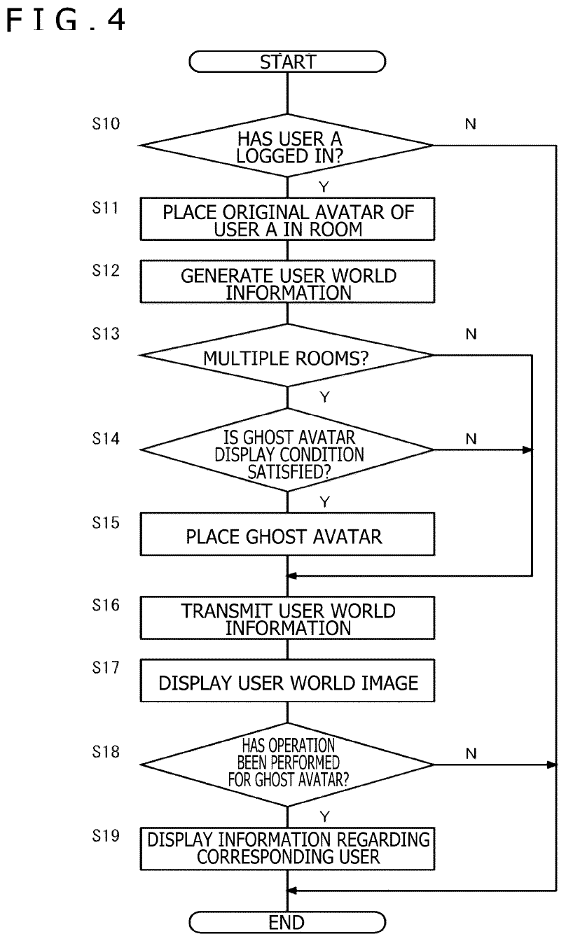

FIG. 4 is a flowchart of operation of the metaverse system 10 according to the embodiment. Hereinafter, operation of the metaverse system 10 will be explained with reference to FIG. 4.

Here, it is assumed that the user A enters a first room of a certain world while the user B is using a second room of the same world. It is to be noted that a known technique may be used for a method for distributing a plurality of users who desire to enter the same world, into a plurality of rooms (instances). For example, if the number of participants in one room reaches an upper limit, a new participant may be led to enter another room.

The user device 14a transmits a log-in request with a designation of an entry destination world to the metaverse server 12 according to a user A operation. The log-in processing section 40 of the metaverse server 12 receives the world log-in request transmitted from the user device 14a. If the log-in request is received (Y at S10), the avatar setting section 46 of the metaverse server 12 places, in the first room, a pre-registered avatar of the user A stored in the user information storage section 36, in a normal form (S11). That is, the avatar setting section 46 places an original avatar of the user A in the first room.

User information stored in the user information storage section 36 according to the embodiment includes, as a first condition, information indicating whether or not the user has permitted to display the avatar (ghost avatar) of the user in a room different from a room that the user has entered. Further, the user information includes, as a second condition, information indicating whether or not the user has permitted to display, in a room that the user has entered, an avatar (ghost avatar) of a different room. The information regarding these conditions may be previously registered in the metaverse server 12 through the user device 14. If the first condition and the second condition are both satisfied, that is, if the user has permitted both the conditions, the avatar setting section 46 determines that a ghost avatar display condition is satisfied.

Specifically, in a case where multiple rooms are present in the world that the user A has entered (Y at S12) and the ghost avatar display condition is satisfied (Y at S13), a ghost avatar of the user B, which corresponds to an original avatar previously registered by the user B and which has relatively high transparency, is placed in the first room (S14). The case where the ghost avatar display condition is satisfied is a case where the user B has permitted to display the avatar of the user B in the first room (i. e., a room different from a room that the user B has entered) and the user A has permitted to display an avatar of a different room in the first room (i.e., a room that the user A has entered).

If the ghost avatar display condition is not satisfied (N at S13), S14 is skipped. If only one room is present in the world that the user A has entered (N at S12), S13 and S14 are skipped.

At S14, the avatar setting section 46 acquires the position where the original avatar corresponding to the user B is placed in the second room, which is recorded in the room information regarding the second room. The avatar setting section 46 places a ghost avatar corresponding to the user B in a position in the first room which is the same as the position in the second room in which the original avatar corresponding to the user B is placed. In the embodiment, the first room and the second room are instances in the same world. Therefore, the avatar setting section 46 places a ghost avatar corresponding to the user B in a position in the first room the same as the placement position of the original avatar corresponding to the user B in the second room. Accordingly, the ghost avatar can be placed in a position that hardly gives a feeling of incompatibility to the user A.

However, there is a possibility that the position of the original avatar corresponding to the user A and the position of the ghost avatar corresponding to the user B overlap in the first room. If so, a feeling of incompatibility is given to the user A. Therefore, in a case where the original avatar corresponding to the user A and the ghost avatar corresponding to the user B are placed within a prescribed range in the first room, the avatar setting section 46 deletes the ghost avatar corresponding to the user B, that is, does not place the ghost avatar corresponding to the user B in the first room. A threshold for the above-mentioned range may be defined to a suitable value based on knowledge of a developer of the metaverse system 10 or an experiment using the metaverse system 10, for example, such that a feeling of incompatibility is not given to the user A.

In a modification, in a case where an original avatar corresponding to the user A and a ghost avatar corresponding to the user B are placed within a prescribed range in the first room, the avatar setting section 46 may place a ghost avatar corresponding to the user B in a position different from a primary placement position of the ghost avatar. In other words, the avatar setting section 46 may place the ghost avatar corresponding to the user B in a position in the first room which is different from the placement position of the original avatar corresponding to the user B in the second room.

Likewise, there is a possibility that the positions of a plurality of ghost avatars overlap in the first room. In a case where a ghost avatar corresponding to the user B and a ghost avatar corresponding to a user C (e. g., a user of a third room) are placed within a prescribed range in the first room, the avatar setting section 46 may delete either one of the ghost avatar corresponding to the user B and the ghost avatar corresponding to the user C. For example, placing the ghost avatar corresponding to the user C in the first room may be abandoned. Further, the avatar setting section 46 may place either the ghost avatar corresponding to the user B or the ghost avatar corresponding to the user C in a position different from the position of the corresponding original avatar. In this manner, in a case where the positions of ghost avatars overlap, the avatar setting section 46 may compare priority of the user B and priority of the user C in a manner described later. The avatar setting section 46 may place only a ghost avatar of a user who has the higher priority in the first room.

The avatar control section 48 of the metaverse server 12 determines a behavior of the original avatar of the user A in the first room on the basis of the avatar operation information transmitted from the user device 14a of the user A. The avatar control section 48 determines a behavior of the original avatar of the user B in the second room on the basis of the avatar operation information transmitted from the user device 14b of the user B.

In addition, the avatar control section 48 causes the ghost avatar of the user B in the first room to behave similarly to the original avatar of the user B in the second room. The avatar control section 48 determines a behavior of the original avatar of the user B in the second room as a behavior of the ghost avatar of the user B in the first room. The position and behavior of the original avatar of the user B in the second room are synchronized with those of the ghost avatar of the user B in the first room, whereby a behavior of the ghost avatar in the first room becomes natural. In other words, the behavior hardly gives a feeling of incompatibility to the user A.

The user world information generation section 50 of the metaverse server 12 generates user world information for the user A (S15). The user world information indicates a situation in the first room where the original avatar of the user A and the ghost avatar of the user B are placed to behave. The user world information transmission section 52 of the metaverse server 12 transmits the user world information to the user device 14a (S16).

The image generation section 80 of the user device 14a generates a user world image which is an image of the first room on the basis of the user world information transmitted from the metaverse server 12. The display control section 72 of the user device 14a displays the user world image on the HMD 16a (S17).

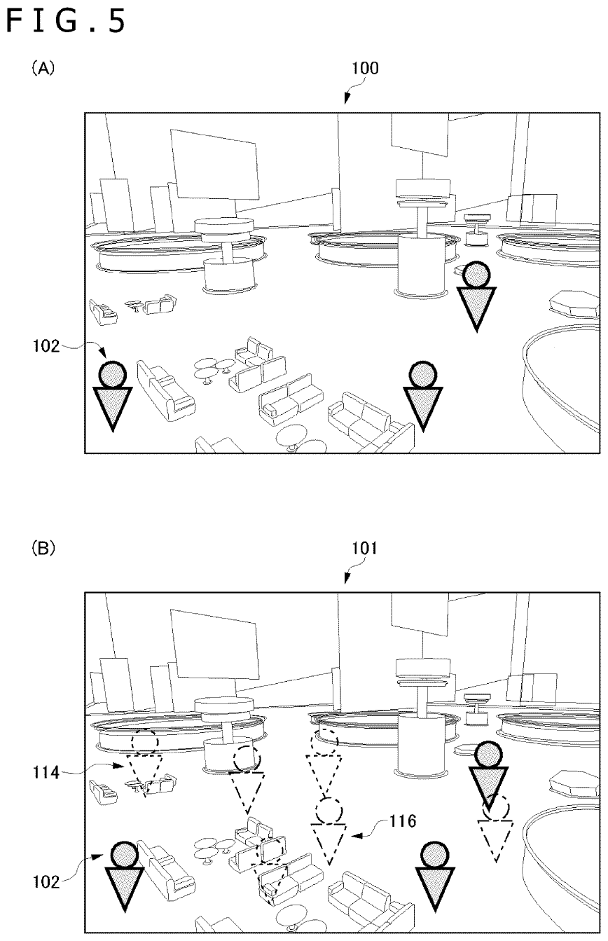

In FIGS. 5(A), 5(B), 6(A), 6(B), 7(A), and 7(B), outlines of an original avatar 102 of a user having entered a first room and a ghost avatar 112 are indicated by solid lines. Outlines of an original avatar 104 of a user having entered a second room and a ghost avatar 114 are indicated by solid lines. Outlines of an original avatar 106 of a user having entered a third room and a ghost avatar 116 are indicated by dashed lines.

FIG. 5(A) depicts an example of a conventional metaverse image 100. An metaverse image 100 in FIG. 5(A) indicates a situation in the first room, and three original avatars 102 (outlines of which are solid lines) are placed in the first room. The three original avatars 102 correspond to three users having entered the first room.

FIG. 5(B) depicts an example of a user world image 101 which is a metaverse image according to the embodiment. The user world image 101 in FIG. 5(B) also indicates a situation in the first room. In the user world image 101 in FIG. 5(B), three ghost avatars 114 and three ghost avatars 116 as well as the three original avatars 102 depicted in FIG. 5(A) are placed. The three ghost avatars 114 correspond to three users having entered the second room. In addition, the three ghost avatars 116 correspond to three users having entered the third room.

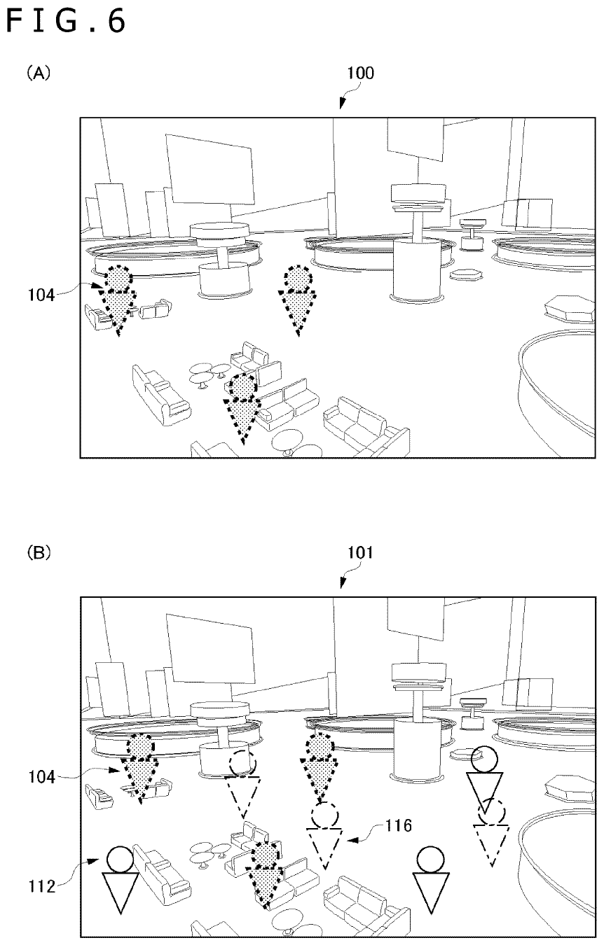

6(A) depicts an example of the conventional metaverse image 100. The metaverse image 100 in FIG. 6(A) indicates a situation in the second room, and three original avatars 104 are placed in the second room. The three original avatars 104 correspond to the three users having entered the second room.

FIG. 6(B) depicts an example of the user world image 101 which is a metaverse image according to the embodiment. The user world image 101 in FIG. 6(B) also indicates a situation in the second room. In the user world image 101 in FIG. 6(B), three ghost avatars 112 and three ghost avatars 116 as well as the three original avatars 104 depicted in FIG. 6(A) are placed. The three ghost avatars 112 correspond to the three users having entered the first room. In addition, the three ghost avatars 116 correspond to three users having entered the third room.

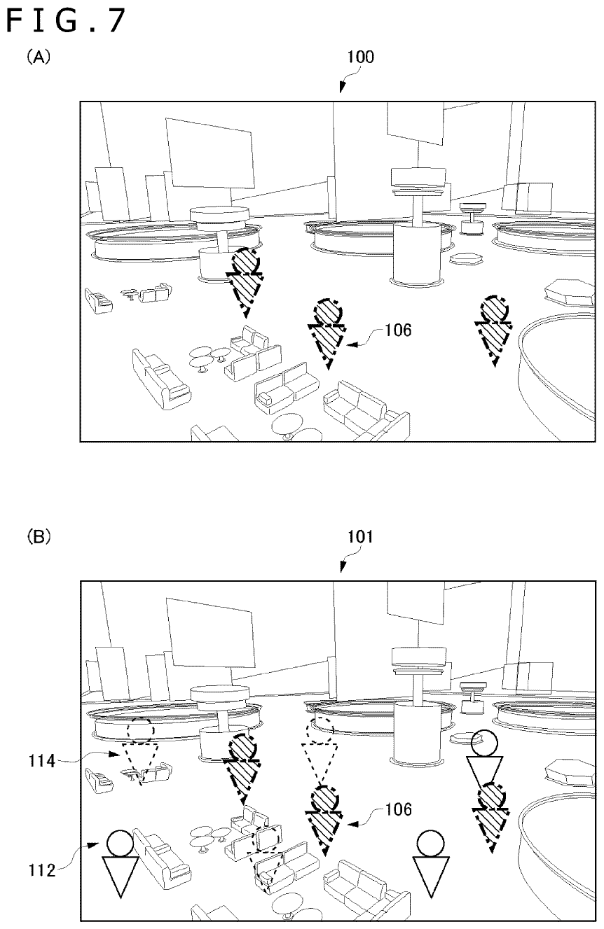

7(A) depicts an example of the conventional metaverse image 100. The metaverse image 100 in FIG. 7(A) indicates a situation in the third room, and three original avatars 106 are placed in the third room. The three original avatars 104 correspond to the three users having entered the third room.

FIG. 7(B) depicts an example of the user world image 101 which is a metaverse image according to the embodiment. The user world image 101 in FIG. 7(B) also indicates a situation in the third room. In the user world image 101 in FIG. 7(B), three ghost avatars 112 and three ghost avatars 114 as well as the three original avatars 106 depicted in FIG. 7(A) are placed. The three ghost avatars 112 correspond to the three users having entered the first room. Also, the three ghost avatars 114 correspond to the three users having entered the second room.

As depicted in FIGS. 5(B), 6(B), and 7(B), the ghost avatars 112 are placed in the same positions as the original avatars 102 in the first room. The ghost avatars 114 are placed in the same positions as the original avatars 104 in the second room. The ghost avatars 116 are placed in the same positions as the original avatars 106 in the third room. In FIGS. 5(B), 6(B), and 7(B), the ghost avatars are placed across the rooms, but the ghost avatars may be placed only in a specific room in a modification.

The ghost avatars 112, the ghost avatars 114, and the ghost avatars 116 are placed in forms depending on which room their original avatars are displayed in. In other words, features are set depending on which room their original avatars are displayed in. By way of example, a blue color may be set for the ghost avatars 112, a yellow color may be set for the ghost avatars 114, and a green color may be set for the ghost avatars 116.

In a case where a specific room (e.g., the first room) and a plurality of rooms (e.g., the second room and the third room) different from the specific room are present, the avatar setting section 46 of the metaverse server 12 places ghost avatars to be displayed in the particular room, in respective forms distinct from one another depending on which room their corresponding original avatars exist in. Such distinct forms may be realized by a difference in at least one of the shapes, the patterns, and the colors.

By way of example, the avatar setting section 46 places, in the first room, a plurality of ghost avatars (ghost avatars 114, ghost avatars 116) of a plurality of users using the second room or the third room in distinct forms depending on which room the users are using, as depicted in FIG. 5(B). The avatar setting section 46 may impart different apparent features to the ghost avatar 114 of a user of the second room placed in the first room, and the ghost avatar 116 of a user of the third room placed in the first room.

Referring back to FIG. 4, the user information stored in the user information storage section 36 includes information that can be disclosed to other users in the other rooms, of the user concerning information (hereinafter, also referred to as “disclosure permitted information”). The disclosure permitted information may include a handle name of a user and identification information of a room that the user has entered, for example.

It is assumed here that a ghost avatar of the user B having entered the second room is placed in the first room that the user A has entered. The user world information generation section 50 of the metaverse server 12 generates, as user world information for the user A, user world information in which the ghost avatar of the user B is associated with the disclosure permitted information regarding the user B. The image generation section 80 of the user device 14a generates a user world image in which the ghost avatar of the user B is associated with the disclosure permitted information regarding the user B.

If a prescribed operation for the ghost avatar corresponding to the user B is inputted from the user A (Y at S18), the display control section 72 of the user device 14a detects the inputted operation on the basis of input information from the controller 18a. In a case where input of the prescribed operation for the ghost avatar corresponding to the user B is detected, the display control section 72 additionally displays, on the user world image, the disclosure permitted information regarding the user B associated with the ghost avatar (S19). Accordingly, minimum information regarding the user B can be provided to the user A, so that an interesting property of an interaction with the ghost avatar can be provided to the user A. In addition, the user A can be led to the second room.

If any prescribed operation for the ghost avatar is not inputted (N at S18), S19 is skipped. If any world log-in request is not received by the metaverse server 12 (N at S10), steps S11 to S19 are skipped.

With the metaverse system 10 according to the embodiment, the number of avatars placed in a metaverse (room) is increased, so that the metaverse can look lively. Accordingly, even if the number of users of a metaverse decreases, the users hardly have an impression that the metaverse is being undercrowding.

The present invention has been explained so far on the basis of the embodiment. The embodiment exemplifies the present invention but a person skilled in the art will understand that various modifications can be made to a combination of the constituent elements or the process steps in the embodiment and that these modifications are also within the scope of the present invention.

A first modification will be explained. In a case where a ghost avatar of the user B having entered the second room is placed in the first room that the user A has entered, the user world information generation section 50 of the metaverse server 12 may add sound information regarding surrounding sounds of the original avatar of the user B in the second room to the user world information for the user A, although any mention of this feature has not been made in the above embodiment.

The user device 14a may further include a sound output control section that controls sound output from a speaker of the HMD 16a. The sound output control section of the user device 14a may output a sound represented by sound information included in the user world information, through a speaker of the HMD 16a. Accordingly, in a case where the viewpoint position of the user A is in the vicinity of the ghost avatar of the user B, the user A can hear a sound in the periphery of the original avatar of the user B, whereby a behavior and a sound regarding the ghost avatar easily coincide with each other and the user A can be further prevented from having a feeling of incompatibility.

A second modification will be explained. The functions of the user device 14 of the above-mentioned embodiment may be implemented in the metaverse server 12. In this case, it is sufficient for the user device 14 to execute a process of displaying, on the HMD 16, data about a user world image provided from the metaverse server 12. Further, the functions of the metaverse server 12 of the above-mentioned embodiment may be implemented in the user device 14. In this case, a process related to a plurality of users or, for example, a process of placing a plurality of users in a room, may be executed by cooperation of a plurality of the user devices 14.

A third modification will be explained. For example, in a case where a limit is imposed on the number of ghost avatars that can be placed in one room, a plurality of users may be prioritized to place their ghost avatars. In this case, the avatar setting section 46 of the metaverse server 12 may place, with a higher probability, a ghost avatar of a certain user who has a higher priority. Regarding the prioritization, a high priority may be given to, for example, a user who has paid a fee regarding ghost user placement. By paying the fee, the user can spread the own avatar and can represent self-assertion. Further, when placing ghost avatars in a room that a certain user has entered, a higher priority may be given to a user who is a friend of this user than a user who is not a friend of this user.

A fourth modification will be explained. In the above-mentioned embodiment, ghost avatar setting is performed across different rooms of the same world. In this modification, ghost avatar setting may be performed across rooms of different worlds (that is, metaverses having different contents). Also in this case, the number of avatars placed in a metaverse is increased, so that the metaverse can look lively.

Any combination of the above-mentioned embodiment and modifications is also valid as an embodiment of the present invention. New embodiment resulting from such combinations have the advantageous effects of the embodiment and modifications included in the combination. In addition, a person skilled in the art will understand that functions that should be implemented by elements set forth in the claims can be achieved by each of or through cooperation of the components illustrated in the embodiment and the modifications. Terms like “first,” “second,” etc., used in the specification and the claims do not indicate an order or importance by any means unless specified otherwise and are used to distinguish a certain feature from the others.

The technical concepts of the above embodiment and modifications can be described as the following techniques.

### Technique 1

An information processing device including:
an avatar setting section that places, in a first metaverse, an avatar corresponding to a first user using the first metaverse; and
a display control section that displays an image of the first metaverse, in which
the avatar setting section further places, in the first metaverse, an avatar corresponding to a second user using a second metaverse that is different from the first metaverse, in a form distinct from the avatar corresponding to the first user.

With this information processing device, the number of avatars placed in the first metaverse is increased, so that the first metaverse can look lively.

### Technique 2

The information processing device according to Technique 1, in which
the first metaverse and the second metaverse are different instances based on the same design information regarding a virtual space, and
the avatar setting section places the avatar corresponding to the second user in a position in the first metaverse corresponding to a position of the avatar corresponding to the second user in the second metaverse.

With this information processing device, the first metaverse and the second metaverse have the same virtual space configuration.

Therefore, the position and behavior of the avatar corresponding to the second user in the first metaverse can be prevented from becoming unnatural, and further, the user of the first metaverse hardly has a feeling of incompatibility.

### Technique 3

The information processing device according to Technique 2, in which,
in a case where the avatar corresponding to the first user and the avatar corresponding to the second user are placed within a prescribed range, the avatar setting section deletes the avatar corresponding to the second user, or places the avatar corresponding to the second user in a different position.

With this information processing device, occurrence of an inconvenience of overlapping of the positions of a plurality of avatars can be suppressed.

### Technique 4

The information processing device according to any one of Techniques 1 to 3, in which
the avatar setting section sets transparency of the avatar corresponding to the second user to be higher than that of the avatar corresponding to the first user.

With this information processing device, the fact that avatars corresponding to users of the second metaverse displayed in the first metaverse are not normal avatars, can be presented to users of the first metaverse in an easy-to-understand manner.

For example, it can be expressed that an interaction cannot be performed with an avatar that is not a normal avatar and corresponds to a user of the second metaverse.

### Technique 5

The information processing device according to any one of Techniques 1 to 4, in which
the avatar setting section adds, to the avatar corresponding to the second user, an object that is indicative of an avatar of a user of a metaverse that is different from the first metaverse.

With this information processing device, the fact that avatars corresponding to users of the second metaverse displayed in the first metaverse are not normal avatars, can be presented to users of the first metaverse in an easy-to-understand manner.

For example, it can be expressed that an interaction cannot be performed with an avatar that is not a normal avatar and corresponds to a user of the second metaverse.

### Technique 6

The information processing device according to any one of Techniques 1 to 5, in which
the second metaverses include a plurality of metaverses that are different from the first metaverse, and
the avatar setting section places, in the first metaverse, a plurality of avatars corresponding to a plurality of the second users each using any one of the plurality of metaverses, in distinct forms depending on which metaverse each of the users is using.

With this information processing device, a metaverse in which an avatar displayed in the first metaverse is primarily displayed can be presented to users of the first metaverse in an easy-to-understand manner.

### Technique 7

The information processing device according to any one of Techniques 1 to 6, in which,
in a case where the second user permits displaying of the avatar of the second user in the first metaverse, the avatar setting section places the avatar corresponding to the second user in the first metaverse.

With this information processing device, it is possible to prevent displaying of the avatar of the second user in the first metaverse against the second user's intension.

### Technique 8

The information processing device according to any one of Techniques 1 to 7, in which
if the first user permits displaying of an avatar of a different metaverse in the first metaverse, the avatar setting section places the avatar corresponding to the second user in the first metaverse.

With this information processing device, it is possible to prevent displaying of the avatar of the second user in the first metaverse against the first user's intension.

### Technique 9

The information processing device according to any one of Techniques 1 to 8, in which
the second users include a plurality of users using the second metaverse, and
the avatar setting section places a plurality of avatars corresponding to the plurality of users in the first metaverse with an upper limit for the number of the avatars defined to be a prescribed number.

With this information processing device, the number of avatars placed in a metaverse can be prevented from becoming excessive.

In other words, an information amount in the metaverse can be prevented from becoming excessive.

### Technique 10

The information processing device according to any one of Techniques 1 to 9, in which,
in a case where a prescribed operation for the avatar corresponding to the second user is inputted from the first user, the display control section additionally displays information regarding the second user.

With this information processing device, useful information can be provided to the first user who is interested in the avatar corresponding to the second user. For example, the information regarding the second user may include information indicating a metaverse being used by the second user.

### Technique 11

An information processing method including:
causing a computer to execute
a step of placing, in a first metaverse, an avatar corresponding to a first user using the first metaverse, and
a step of displaying an image of the first metaverse, in which, in the placing step, an avatar corresponding to a second user using a second metaverse that is different from the first metaverse is further placed, in a form distinct from the avatar corresponding to the first user, in the first metaverse.

With this information processing method, the number of avatars placed in the first metaverse is increased, so that the first metaverse can look lively.

### Technique 12

A computer program for causing a computer to implement:
a function of placing, in a first metaverse, an avatar corresponding to a first user using the first metaverse; and
a function of displaying an image of the first metaverse, in which,
in the placing function, an avatar corresponding to a second user using a second metaverse that is different from the first metaverse is further placed, in a form distinct from the avatar corresponding to the first user, in the first metaverse.

With this computer program, the number of avatars placed in the first metaverse is increased, so that the first metaverse can look lively.

### INDUSTRIAL APPLICABILITY

The technique of the present disclosure is applicable to an information processing system and an information processing device, etc.

### REFERENCE SIGNS LIST

10: Metaverse system
12: Metaverse server
14: User device
44: World management section
46: Avatar setting section
50: User world information generation section
52: User world information transmission section
72: Display control section
80: Image generation section

1. An information processing device comprising:
an avatar setting section that places, in a first metaverse, an avatar corresponding to a first user using the first metaverse; and
a display control section that displays an image of the first metaverse, wherein
the avatar setting section further places, in the first metaverse, an avatar corresponding to a second user using a second metaverse that is different from the first metaverse, in a form distinct from the avatar corresponding to the first user.

2. The information processing device according to claim 1, wherein
the first metaverse and the second metaverse are different instances based on same design information regarding a virtual space, and
the avatar setting section places the avatar corresponding to the second user in a position in the first metaverse corresponding to a position of the avatar corresponding to the second user in the second metaverse.

3. The information processing device according to claim 2, wherein,
in a case where the avatar corresponding to the first user and the avatar corresponding to the second user are placed within a prescribed range, the avatar setting section deletes the avatar corresponding to the second user, or places the avatar corresponding to the second user in a different position.

4. The information processing device according to claim 1, wherein
the avatar setting section sets transparency of the avatar corresponding to the second user to be higher than that of the avatar corresponding to the first user.

5. The information processing device according to claim 1, wherein
the avatar setting section adds, to the avatar corresponding to the second user, an object that is indicative of an avatar of a user of a metaverse that is different from the first metaverse.

6. The information processing device according to claim 1, wherein
the second metaverses include a plurality of metaverses that are different from the first metaverse, and
the avatar setting section places, in the first metaverse, a plurality of avatars corresponding to a plurality of the second users each using any one of the plurality of metaverses, in distinct forms depending on which metaverse each of the users is using.

7. The information processing device according to claim 1, wherein,
in a case where the second user permits displaying of the avatar of the second user in the first metaverse, the avatar setting section places the avatar corresponding to the second user in the first metaverse.

8. The information processing device according to claim 1, wherein
if the first user permits displaying of an avatar of a different metaverse in the first metaverse, the avatar setting section places the avatar corresponding to the second user in the first metaverse.

9. The information processing device according to claim 1, wherein
the second users include a plurality of users using the second metaverse, and
the avatar setting section places a plurality of avatars corresponding to the plurality of users in the first metaverse with an upper limit for the number of the avatars defined to be a prescribed number.

10. The information processing device according to claim 1, wherein,
in a case where a prescribed operation for the avatar corresponding to the second user is inputted from the first user, the display control section additionally displays information regarding the second user.

11. An information processing method comprising:
causing a computer to execute
placing, in a first metaverse, an avatar corresponding to a first user using the first metaverse, and
displaying an image of the first metaverse, wherein,
in the placing, an avatar corresponding to a second user using a second metaverse that is different from the first metaverse is further placed, in a form distinct from the avatar corresponding to the first user, in the first metaverse.

12. A computer program for a computer, comprising:
by an avatar setting section, placing, in a first metaverse, an avatar corresponding to a first user using the first metaverse; and
by a display control section, displaying an image of the first metaverse, wherein,
in the placing function, an avatar corresponding to a second user using a second metaverse that is different from the first metaverse is further placed, in a form distinct from the avatar corresponding to the first user, in the first metaverse.
